(19) United States
(12) Patent Application Publication
(10) Pub. No.: US 2026/0264357 A1
(43) Pub. Date: Sep. 10, 2026

(54) MULTIFUNCTIONAL AUTOMATIC THERMAL PRESS

(71) Applicant: Zhiyong Zhang, Yingcheng (CN)

(72) Inventor: Zhiyong Zhang, Yingcheng (CN)

(21) Appl. No.: 19/084,831

(22) Filed: Mar. 20, 2025

(30) Foreign Application Priority Data
Mar. 4, 2025 (CN) 2025203665655

(51) Int. Cl. B30B 15/06

(52) U.S. Cl. CPC B30B 15/064

(57) ABSTRACT

The present invention provides a multifunctional automatic heat press, including: the whole machine body, control screen, cup machine part, cap baking machine part, ironing machine part and accessories storage; the cup machine part includes cup mat closing angle automatic adjustment device, the cup machine moving bracket, cup machine motor, cup machine motor screw, one or more specifications. A multi-functional automatic thermal press, by integrating the automatic baking machine, the automatic ironing machine and the automatic baking machine, realizes that the equipment has a variety of thermal pressing functions, greatly expands the application scope of the equipment, meets the diversified production needs of users, reduces the high purchase cost for the purchase of multiple single function equipment, reduces the floor area of the equipment and improves the space utilization rate by reducing the quantity of equipment.

### TECHNICAL FIELD

The invention relates to the technical field of hot pressing equipment, in particular to a multifunctional automatic hot press.

### BACKGROUND TECHNOLOGY

In the existing market, hot pressing equipment is widely used in cup, hot painting, hot stamping and other fields.

Yet, At present, the thermal pressing equipment on the market is a single function, If you need to perm the cup, hot draw, hot cap and other operations at the same time, Users need to purchase multiple different types of thermal pressing equipment, Or purchase the so-called manual multi-function ironing machine that simply bundles all kinds of manual ironing machines together and is actually scattered independently, This has not only led to a significant increase in equipment procurement costs, And multiple devices take up lots of space, The operation shall be familiar with the operation process of different equipment, Complex and inefficient operation, at the same time, Energy consumption and maintenance costs of individual devices are also higher, It is not conducive to the efficient production and cost control of enterprises or individuals.

Therefore, it is necessary to provide a multi-function automatic thermal press to solve the above technical problems.

### INVENTION CONTENT

The present invention provides a multi-function automatic thermal press that solves the problems of single function, high procurement cost, large space occupation, complex and low efficiency operation, and high energy consumption and maintenance cost.

In order to solve the above technical problems, the present invention provides a multifunctional automatic thermal press, comprising:

Machine box, control screen, toast machine, baking machine, ironing drawing machine and accessories storage.

preferably, the toaster portion includes a toaster, a toaster closing angle automatic adjusting device, a toaster moving bracket, a toaster motor, a toaster motor screw, the toaster closing angle automatic adjusting device and the toaster moving bracket rotational connection, the one or more specifications set on the inner side of the toaster closing angle moving bracket, the toaster motor screw thread is connected to the interior of the toaster moving bracket, the output of the toaster motor screw and the toaster motor screw are mounted.

Preferred of all, The hat machine part includes hat machine main shell, hat machine heating plate, cap plate, cap machine hat fixed support frame, hat machine pull mobile workbench, hat machine pull mobile table slide, hat machine heating plate rise down motor, the hat machine fall to receive rotating shaft and cap machine set up support device, The mounting support device is provided on the inner side of the machine body, The rotation connection between the falling storage rotating shaft and the standing support device of the cap baking machine, The main housing is connected to the outer side of the rotating shaft of the cap machine, The descending motor of the heating plate is provided at the top of the main shell of the cap machine, The heating plate of the baking machine is provided at the mobile terminal of the descending motor of the heating machine, The cap cap fixing support holder is provided on the inner side of the main shell of the cap machine, The sliding rail of the movable table is fixed and mounted on both sides of the inner side of the cap, The movable table is fixed in the middle of the sliding rail of the movable table, The cap stamping table is set at the top of the moving work table.

preferably, the ironing machine drawer workbench, the ironing machine table pad, the drawing machine heating plate, the ironing machine heating plate lifting motor, the ironing machine drawer workbench is sliding connected to the inner side of the whole machine box body, the ironing machine table pad is provided in the top of the ironing machine drawer workbench, the ironing machine heating plate lifting motor is provided in the inner side of the whole machine box body, the ironing machine heating plate and the ironing machine heating plate of the mobile end of the lifting motor fixed installation.

Prepreferred, the 1 or more cups and plates of various shapes and sizes are usually stored in the storage place of accessories for replacement by customers.

Compared with the related techniques, a multi-function automatic thermal press provided by the present invention has the following beneficial effects:

The invention provides a multi-function automatic hot press, by integrating the cup machine part, the ironing machine part and the cap machine part in the same thermal press, the realization of a equipment has a variety of thermal press functions, greatly expand the application scope of the equipment, and meet the diversified production needs of users;

It reduces the high procurement cost required for users to purchase multiple single function equipment, reduces the footprint of equipment, improves the utilization of space, and due to the reduction of the number of equipment, energy consumption and maintenance costs are correspondingly reduced;

Using a unified control system control screen, users only need to be familiar with a set of operation process to operate a variety of thermal pressing functions, the operation is simple and convenient, improve the work efficiency, at the same time, accurate temperature, pressure and time control, to ensure the quality stability of thermal pressing products.

### ATTACHED FIGURE DESCRIPTION

FIG. 1 is a schematic diagram of a preferred embodiment of a multifunctional automatic thermal press provided by the present invention;

FIG. 2 shows the schematic diagram of the structure as shown in FIG. 1 ;

FIG. 3 is the schematic diagram of the unfolding structure shown in FIG. 1;

FIG. 4 is a schematic diagram of the alternative visual view structure shown in FIG. 1;

FIG. 5 is the internal structure diagram shown in FIG. 1;

FIG. 6 shows the schematic diagram of the structure as shown in FIG. 2;

FIG. 7 shows the schematic diagram of the ironing as shown in FIG. 3;

FIG. 8 is a schematic view of an embodiment of a second multifunctional automatic thermal press provided by the present invention:

FIG. 9 is the schematic diagram of the partial unfolding structure shown in FIG. 8;

FIG. 10 is a schematic diagram of the structure shown in FIG. 8;

FIG. 11 is the internal structure diagram shown in FIG. 8;

FIG. 12 is a schematic diagram of the structure shown in FIG. 10;

FIG. 13 is a schematic diagram of the structure shown in FIG. 10;

FIG. 14 is a schematic view of an embodiment of another multifunctional automatic thermal press provided by the present invention:

FIG. 15 is the schematic diagram of the structure shown in FIG. 14;

FIG. 16 is a schematic diagram of the unfolding structure shown in FIG. 14;

FIG. 17 is a schematic internal structure shown in FIG. 14;

FIG. 18 is the schematic diagram of the structure shown in FIG. 15;

FIG. 19 is a schematic diagram of the partial unfolding structure shown in FIG. 16.

### SPECIFIC IMPLEMENTATION METHOD

The present invention is further explained below in combination with the accompanying drawings and the embodiments.

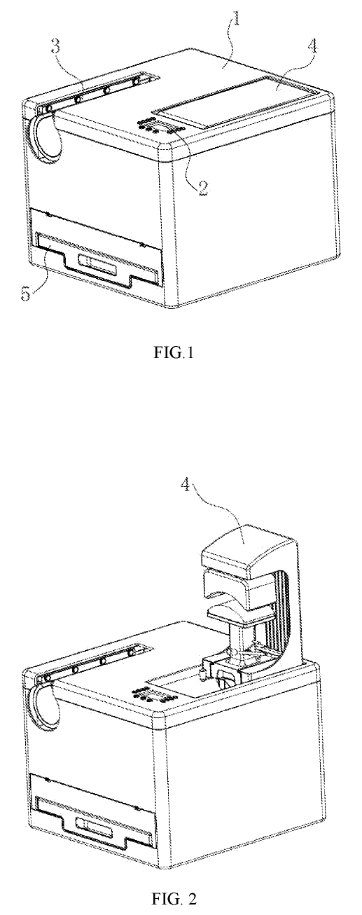

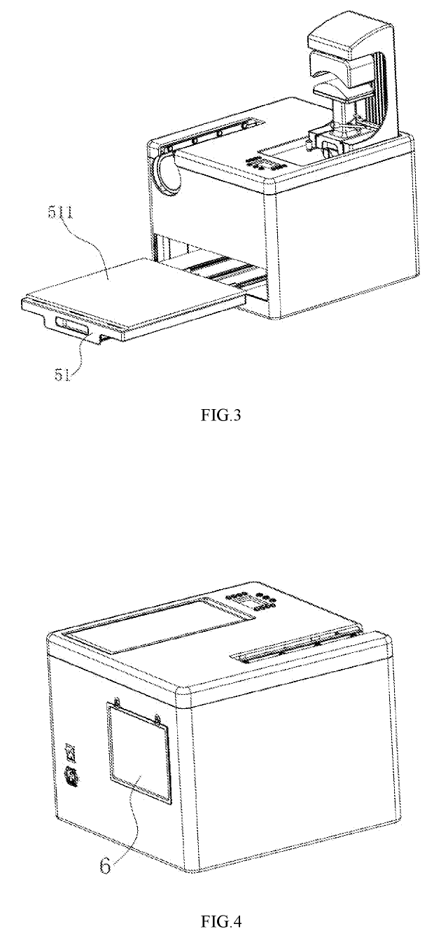

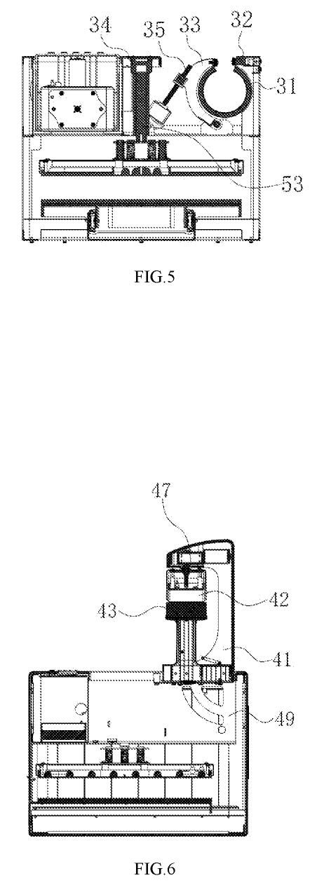

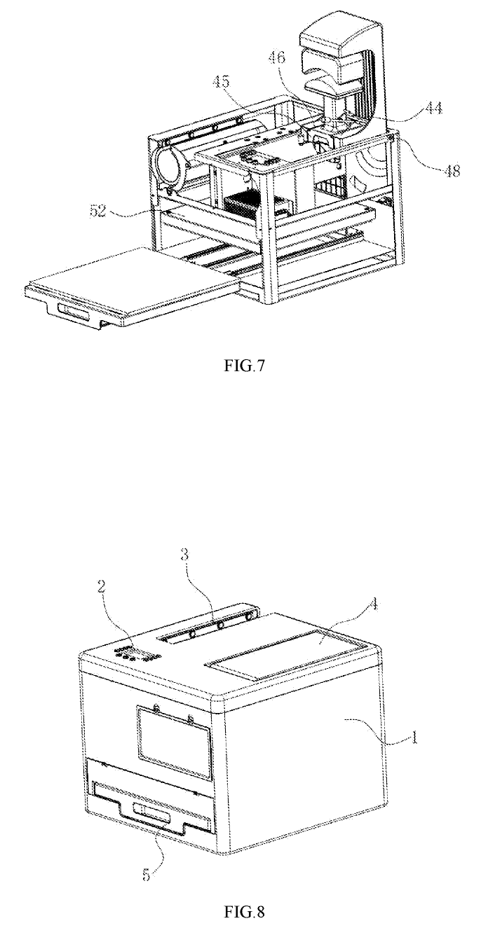

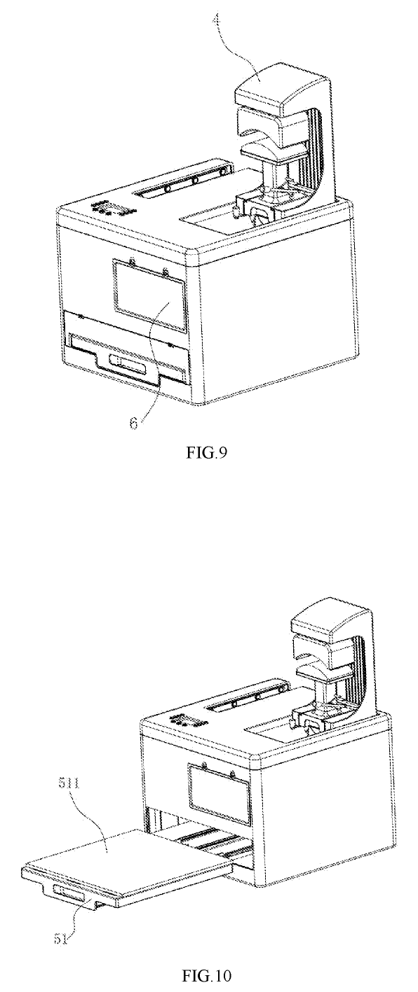

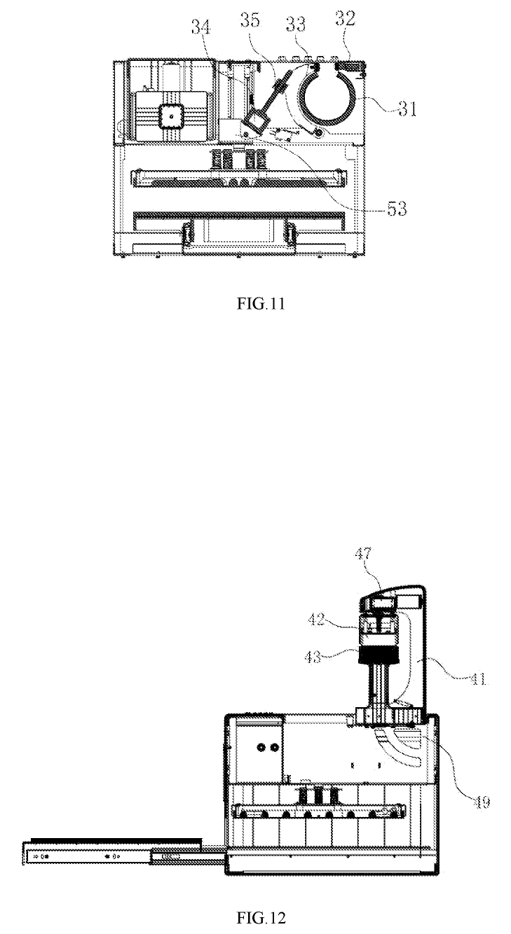

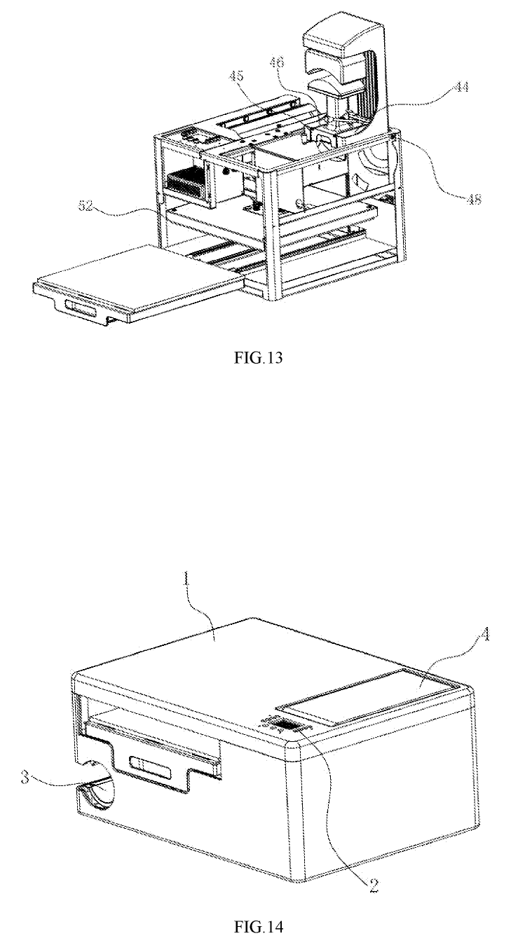

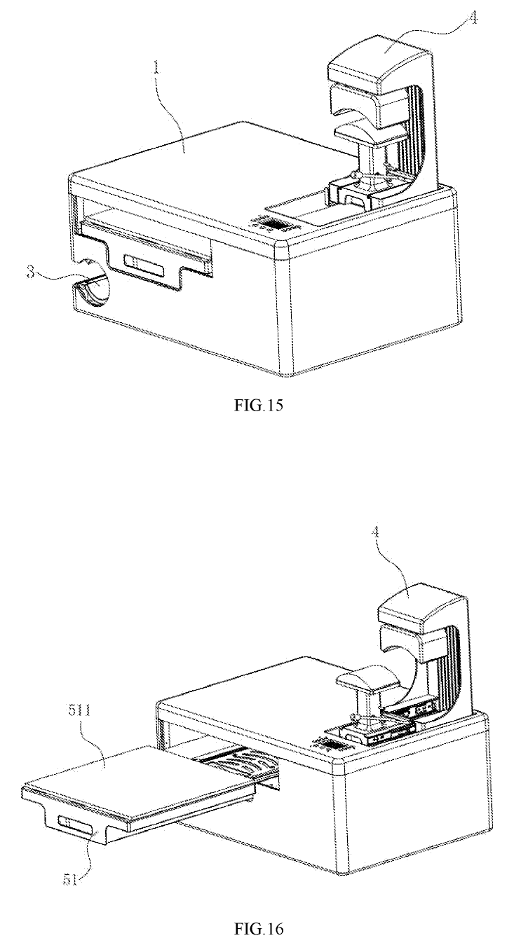

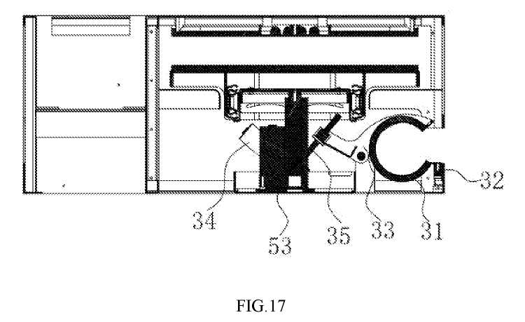

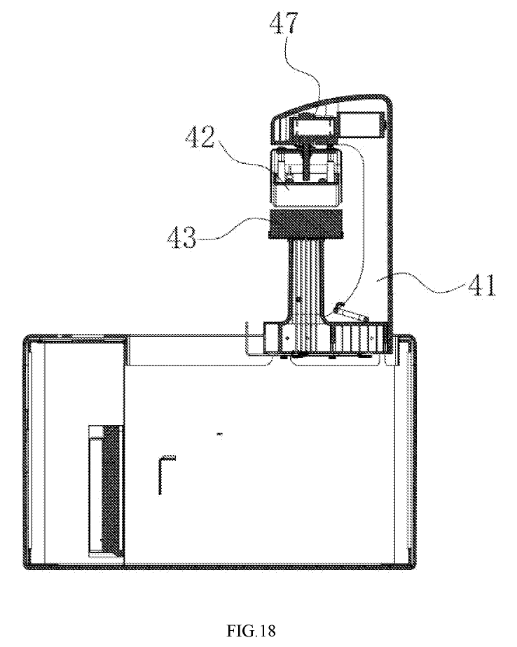

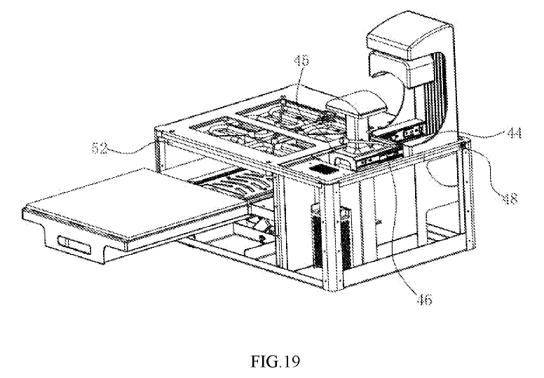

Please refer to FIGS. 1, 2, 3, 4, 5, 6, 7, 8, 9, 10, 11, 12, 13, 14, 15, 16, 17, 18 and 19, among, FIG. 1 is a schematic diagram of a preferred embodiment of a multifunctional automatic thermal press provided by the present invention; FIG. 2 shows the schematic diagram of the structure as shown in FIG. 1; FIG. 3 is the schematic diagram of the unfolding structure shown in FIG. 1; FIG. 4 is a schematic diagram of the other visual view structure shown in FIG. 1; FIG. 5 is the internal structure diagram shown in FIG. 1; FIG. 6 shows the schematic diagram of the structure as shown in FIG. 2; FIG. 7 is the schematic diagram of the unfolding structure shown in FIG. 3; FIG. 8 is a schematic view of an embodiment of a second multifunctional automatic thermopress provided by the present invention, FIG. 9 shows the schematic diagram of the unfolding structure shown in FIG. 8; FIG. 10 is a schematic diagram of the unfolding structure shown in FIG. 8; FIG. 11 is the internal structure diagram shown in FIG. 8; FIG. 12 is the schematic diagram of the structure shown in FIG. 2; FIG. 13 is a schematic diagram of the unfolding structure shown in FIG. 2; FIG. 14 is a schematic view of an embodiment of another multifunctional automatic thermal press provided by the present invention, FIG. 15 is the schematic diagram of the structure shown in FIG. 14; FIG. 16 is a schematic diagram of the unfolding structure shown in FIG. 14; FIG. 17 is a schematic diagram of the internal structure shown in FIG. 14; FIG. 18 is the schematic diagram of the structure shown in FIG. 15; FIG. 19 is a schematic diagram of the partial unfolding structure shown in FIG. 16.

A multifunctional automatic hot press, including: the machine body 1, control screen 2, toast machine part 3, hat baking machine part 4, ironing machine part 5 and accessory storage 6 .

The toaster portion 3 includes a toaster mat closing mouth angle automatic adjusting device 32, a toast machine movable holder 33, a toast machine motor 34, a toast machine motor screw 35, one or more specifications of toasters 31, Turning connection between the closing angle automatic adjusting device 32 and the toaster moving holder 33, The one or more sizes of the toasters 31 are provided on the inner sides of the grill closing mouth angle automatic adjusting device 32 and the toaster moving holder 33, The screw of the motor screw 35 is threaded to the inside of the moving bracket 33, The output of the motor screw 35 and the motor screw 35 are mounted.

The cap baking machine part 4 including hat machine body shell 41, cap machine heating plate 42, cap baking machine hat hot stamping table 43, hat machine hat fixed support frame 44, hat machine pull mobile table 45, hat machine pull moving table slide rail 46, hat machine heating plate rise down motor 47, hat machine fall receive rotating shaft 48 and hat machine set up support device 49, The cap-mount support device 49 is provided on the inner side of the machine body 1, Turning connection between the rotating shaft 48 and the cap machine lifting support device 49, The main housing 41 is connected to the outer side of the rotating shaft 48, The descending motor 47 is provided at the top of the main housing 41, The heating plate 42 is provided on a mobile terminal of the heating plate rising drop motor 47, The cap fixing holder 44 is provided on the inner side of the main housing 41, The cap machine pulls the movable table rail 46 are fixed on both sides of the inner sides of the cap holder 44, The movable table 45 is fixed in the middle of the slide rail 46, The cap stamping table 43 is provided at the top of the moving table 45.

The ironing machine section 5 includes a drawer worktable 51, a drawing table pad 511, a heating plate 52, a heating plate lifting motor 53, and a drawer worktable 51, the table pad 511 is disposed at the top of the drawer table 51, the heating plate lifting motor 53 is mounted on the inner side of the machine body 1, the heating plate 52 and the mobile terminal of the heating plate lifting motor 53.

The 1 or more cups and baking tray pads used for various shapes and sizes are usually stored in the storage place of accessories for replacement by customers.

Different from the existing manual multi-functional ironing machine on the market (or called five-in-one ironing machine, eight-in-one ironing drawing machine, multi-in-one ironing machine) is by a number of independent functions to remove the control screen or control box after the rest of the host part is all installed in a packaging box, Use a single set of control screen or control box, The product is messy without a design sense, In addition, because the user needs to use tools to disassemble and assemble, resulting in poor experience and damage, The invention all overcomes the above problems and designed the world with completely different design creation ideas, Make it easier for users to use, more stable quality, small volume, light weight, lower cost, Can can print at most of three different products at the same time, And there is no need to use manpower.

The coaster 31 is made of high temperature resistance and high elasticity, The material can fit tightly to different shapes of cups, It can also remain stable at high temperatures, Does not release harmful substances that affect the quality of the cup, Grclosing angle automatic adjustment device 32, According to the shape of the cup, the cup such as a certain taper can automatically adapt to ensure that the whole cup from top to bottom pressure can be tightly pressed to ensure the quality of hot stamping, The cup baking machine movable bracket 33 is connected to the whole machine box by high strength metal slide, Ensure that when the toaster motor 34 drives the motor screw 35 is turning, Activity bracket 33 is able to move smoothly and smoothly, Make the baking aster precisely closed and separate, 17 oz tapered toasters 36 and 12 oz toasters 37 fit tapered cups of different capacities and sizes, respectively, Its surface design has a unique texture, Can increase the friction with the cup, Prevent the cup from sliding during hot pressing, It also helps to transfer heat more evenly;

The main shell of the hat machine part 4 is made of engineering plastic material of fire prevention and heat insulation, Not only ensures the safety of use, Can also effectively reduce heat loss; The heating plate 42 uses an efficient electric heating tube, Fast heating speed and good temperature uniformity; The cap hot stamping table 43 is covered with a layer of soft silicone pad, To protect the hat from scratches, And can make the hat in the process of hot stamping to better fit with the heating plate; The cap cap fixing support bracket 44 is designed with an adjustable structure, By rotating the adjustment knob, Can adapt to hats of different sizes and shapes, Ensure that the cap is stable during thermal pressing; Table 45 works closely with the slide rail 46, The slide rail uses high-precision ball bearings, Make the workbench easy and smooth during sliding, Convenient for users to place and take hats; Roat baking machine heating plate rise drop motor 47 selected large torque, high precision of the motor, Can accurately control the rising and falling height of the heating plate, Ensure that the heating plate is in accurate contact with the hat and applies appropriate pressure; The hat machine falling storage rotating shaft 48 and the cap machine standing support device 49 adopt solid metal material, The collapsed storage rotation shaft 48 is equipped with a damping device, Can slow down, Avoid equipment damage caused by excessive speed; The upright support device 49 has a reliable locking function, When the hat grill stands up, Can be stable support, Prevent dumping;

The drawer type table 51 of the ironing drawing part 5 adopts light and strong aluminum alloy material, The surface was treated with oxidation, Wear-resistant and not easy to rust; Table mat 511 uses soft silicone or other high temperature resistant soft material, Can effectively buffer the pressure when the heating plate drops, Protect hot items from crushing, At the same time, it can also make the items in the process of ironing painting to keep flat; The heating plate 52 adopts an electric heating pipe with high quality and stable life, Teflon paint or ceramic paint is sprayed on the surface to prevent the dirt from sticking to the heating plate and thus dirty the clothes or other products during the hot stamping process, Rapid heating and a uniform temperature, Can ensure the quality of the pattern hot stamping; Hot machine heating plate lifting motor 53 selects a large torque high precision motor or deceleration motor through the whole controller to control its travel distance or travel time and the limit switch to achieve the precise control of the heating plate lifting height; ¢ 120mm baking pad and ¢ 150mm baking pad are suitable for different sizes of ironing items, The baking pan mat is made of high-temperature resistant, anti-stick Teflon material, Convenient for cleaning, Can effectively avoid the pattern in the process of hot stamping stuck on the baking sheet pad;

The working principle of a multifunctional automatic thermal press provided by the present invention is as follows:

Bake Cup Operation: First, Part 3 has a 30 oz straight barrel coaster, In addition, if the operator needs to print more sizes or specifications of cups, he can take out the appropriate baking coaster from the accessory storage place 6, Such as a 17 oz tapered coaster or a 12 oz tapered coaster, Replace the baking aster 31; Place the cup to be pressed wrapped in the beautiful picture between the coasters, Start the toaster part 3; Roaster motor 34 drive toaster motor screw 35 rotation, Move the cup aster moving holder 33, Keep the toaster mat closed, Wrap the cup tightly; The angle automatic adjusting device 32 will depend on the shape of the cup, Automatically adjust the angle of the closed closed, Ensure that all parts of the cup are heated evenly; this moment, The heating element of the graster part 3 starts working, Heat the cup. The control screen 2 and other parameters can be set on the heating temperature and time. After the set time is reached, the cup grill motor 34 is reversed, and the cup grill moving bracket 33 drives the cup mat to separate, and takes out the cup that completes the hot pressing;

Roast cap operation: open the cap baking machine part 4, place the cap on the cap hot stamping table, and fix the cap; start the cap baking machine through the control screen 2, and the motor 47 drives the heating plate to drop and contact with the cap. During contact, the heating plate transfers heat to the cap to achieve thermal compression. After completing the hot pressure, the heating plate of the cap oven drives the heating plate of the cap oven to rise and remove the cap oven to handle the rotating shaft 48 to slide on the slide rail of the cap oven, so as to place and take the cap .

Hot drawing operation: after the temperature of the heating plate is up to the set temperature, place the hot drawing items (such as clothes, other plane products, etc.) on the hot drawing machine bench pad 511 through the control screen 2 and the hot plate lifting motor 53 drive the hot plate 52 down, contact with the items and apply pressure. During the heating process, the pattern is printed on the item; the heating plate lifting motor 53 drives the heating plate 52 to rise, and pulls out the drawer drawing table 51 .

Hot printing plate operation: share the hot drawing part, After the heating plate temperature rises to the set temperature, Place the baking pan pad of￠120mm or ¢ 150mm in the middle of the ironing pan table pad 511, On the baking tray pad of ¢ 120mm or ¢ 150mm, Start the ironing machine through the control screen 2, Hot drawing machine heating plate lifting motor 53 drive hot drawing machine heating plate down, Contact with the bottom of the plate and apply pressure, After the countdown ends, Hot drawing machine heating plate lifting motor 53 drive hot drawing machine heating plate 52 up, Pull out the ironing machine drawer type workbench 51, Remove the hot-printed plate .

Compared with the related techniques, a multi-function automatic thermal press provided by the present invention has the following beneficial effects:

By integrating the baking machine part 3, the hot drawing machine part 5 and the cap baking machine part 4 into the same thermal press, a equipment has a variety of thermal pressing functions, greatly expanding the application scope of the equipment, and meets the diversified production needs of users;

It reduces the high procurement cost required for users to purchase multiple single function equipment, reduces the footprint of equipment, improves the utilization of space, and due to the reduction of the number of equipment, energy consumption and maintenance costs are correspondingly reduced;

Using a unified control system control screen 2, users only need to be familiar with a set of operation process to operate a variety of thermal pressing functions, the operation is simple and convenient, improve the work efficiency, at the same time, accurate temperature, pressure and time control, to ensure the quality stability of hot pressing products.

The above is only the embodiment of the invention, is not therefore limit the scope of the patent of the invention, the use of the invention specification and the drawings of the equivalent structure or equivalent process transformation, or directly or indirectly used in the same way, as the design of the design of the layout, orientation, size, spare parts, alternative, color of the protection of the invention .

1. A multifunctional automatic thermal press characterized by:
Machine box, control screen, toast machine, baking machine, ironing drawing machine and accessories storage.

2. A multifunctional automatic thermal press according to claim 1, It is characterized by the fact that, The toaster part includes a toaster mat closing mouth angle automatic adjusting device, a toaster machine movable bracket, toaster machine motor, toaster machine motor screw, one or more baking coaster of the specifications, The rotation connection between the cup holder and the movable holder of the baking machine, The one or more sizes of the toaster coaster are provided on the inner sides of the grill coaster closing mouth angle automatic adjustment device and the toaster movable holder, The screw thread of the grill motor is connected to the interior of the movable holder, The output end of the motor screw and the motor screw are fixed.

3. A multifunctional automatic thermal press according to claim 1, It is characterized by the fact that, The hat machine part includes hat machine main shell, hat machine heating plate, cap plate, cap machine hat fixed support frame, hat machine pull mobile workbench, hat machine pull mobile table slide, hat machine heating plate rise down motor, the hat machine fall to receive rotating shaft and cap machine set up support device, The mounting support device is provided on the inner side of the machine body, The rotation connection between the falling storage rotating shaft and the standing support device of the cap baking machine, The main housing is connected to the outer side of the rotating shaft of the cap machine, The descending motor of the heating plate is provided at the top of the main shell of the cap machine, The heating plate of the baking machine is provided at the mobile terminal of the descending motor of the heating machine, The cap machine cap fixing holder is provided on the inner side of the cap machine body housing, The sliding rail of the movable table is fixed and mounted on both sides of the inner side of the cap, The movable table is fixed in the middle of the sliding rail of the movable table, The cap stamping table is set at the top of the moving work table.

4. A multi-function automatic hot press according to claim 1, wherein the ironing machine section includes ironing machine drawer working table, ironing machine table pad, ironing machine heating plate lifting motor, the inner side of the whole machine box, the ironing machine table pad is provided at the top of the drawer working table, the ironing machine heating plate lifting motor is provided on the inner side of the whole machine box, the ironing machine heating plate and the mobile end of the lifting plate of the ironing machine are mounted.

5. A multi-function automatic hot press according to claim 1, characterized in that the one or more cups and plates of various shapes and sizes are stored in the accessory storage place for replacement.
